(19) United States
(12) Patent Application Publication
(10) Pub. No.: US 2021/0366018 A1
(43) Pub. Date: Nov. 25, 2021

(54) SERVER AND METHOD FOR AVOIDING REGISTERED MATERIALS

(71) Applicant: TOSHIBA TEC KABUSHIKI KAISHA, Tokyo (JP)

(72) Inventor: Yuichi OGAWA, Izunokuni Shizuoka (JP)

(73) Assignee: TOSHIBA TEC KABUSHIKI KAISHA, Tokyo (JP)

(21) Appl. No.: 17/396,959

(22) Filed: Aug. 9, 2021

Related U.S. Application Data
(63) Continuation of application No. 16/421,709, filed on May 24, 2019.

(30) Foreign Application Priority Data
May 25, 2018 (JP) 2018-100775

(51) Int. Cl. G06Q 30/06

(52) U.S. Cl. CPC G06Q 30/0627; G06Q 30/0639

(57) ABSTRACT

In this disclosure, a server includes a reception module configured to receive a commodity code that can identify a commodity; a first extraction module configured to extract material information in which raw materials contained in the commodity specified by the commodity code received by the reception module are registered; a second extraction module configured to extract avoidance information in which avoidance material indicating a raw material that a customer avoids is registered; a third extraction module configured to extract commodity information of a commodity that does not contain the avoidance material on the condition that the material information extracted by the first extraction module includes the avoidance material registered in the avoidance information extracted by the second extraction module; and a first transmission module configured to transmit the commodity information extracted by the third extraction module.

### CROSS-REFERENCE TO RELATED APPLICATION

This application is based upon and claims the benefit of priority from Japanese Patent Application No. 2018-100775, filed on May 25, 2018, the entire contents of which are incorporated herein by reference.

### FIELD

Embodiments described herein relate generally to a server and a method.

### BACKGROUND

In a restaurant or the like, certain conventional technology may display or show a menu corresponding to an allergy to prevent a customer who has the allergy from ingesting a substance that causes an allergic reaction, which is referred herein as an allergic substance.

It is necessary to prevent a customer who has the allergy from ingesting an allergic substance from not only food purchased in a restaurant but also a commodity purchased in a retail store such as a supermarket and a convenience store. In recent years, more and more customers tend to avoid a commodity containing a certain raw material for religious reasons, etc. The customer who avoids the certain raw material needs to confirm raw materials shown in the commodity for each commodity.

However, if there is a plurality of commodities to be purchased, it is troublesome to confirm the raw materials of all the commodities. Furthermore, if the avoided raw material is included, the customer has to look for another commodity that does not have the raw material.

### DESCRIPTION OF THE DRAWINGS

FIG. 1 is a diagram illustrating an example of a commodity purchase auxiliary system according to an embodiment;

FIG. 2 is a block diagram illustrating an example of a hardware configuration of a customer terminal;

FIG. 3 is a diagram illustrating an example of a data structure of avoidance information;

FIG. 4 is a block diagram illustrating an example of a hardware configuration of a commodity server;

FIG. 5 is a diagram illustrating an example of a data structure of a commodity master file;

FIG. 6 is a block diagram illustrating an example of characteristic functional components of various devices in the commodity purchase auxiliary system;

FIG. 7 is a diagram illustrating an example of a warning screen;

FIG. 8 is a diagram illustrating an example of a substitute commodity screen; and

FIG. 9 is a flowchart depicting an example of an auxiliary processing.

### DETAILED DESCRIPTION

In accordance with an embodiment, a server (e.g., a computer, a device, or a program that manages network resources and data among the network resources) comprises a reception module configured to receive a commodity code capable of identifying a commodity; a first extraction module configured to extract material information in which raw materials contained in the commodity specified by the commodity code received by the reception module are registered; a second extraction module configured to extract avoidance information in which avoidance material indicating a raw material that a customer avoids is registered; a third extraction module configured to extract commodity information of a commodity that does not contain the avoidance material on the condition that the material information extracted by the first extraction module includes the avoidance material registered in the avoidance information extracted by the second extraction module; and a first transmission module configured to transmit the commodity information extracted by the third extraction module.

Hereinafter, an embodiment of a server and a method is described in detail with reference to the accompanying drawings. The embodiment described below is merely an embodiment of the server and the method, and is not intended to limit the configuration and the specification thereof. The server and the method of the present embodiment are application examples of a commodity purchase auxiliary system to a commodity server.

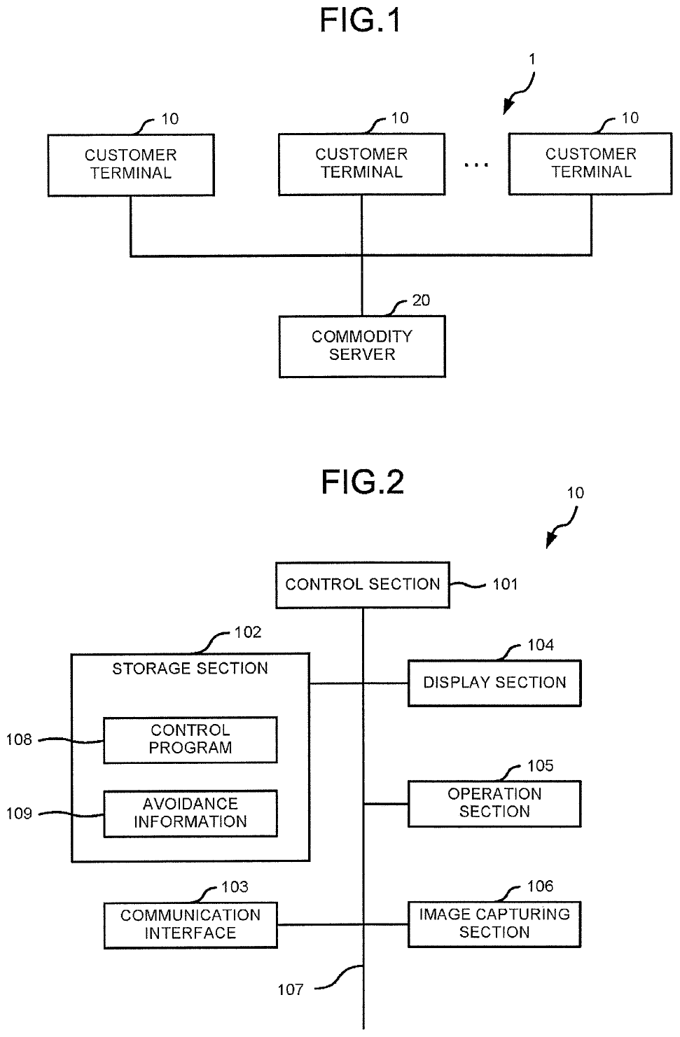

FIG. 1 is a diagram illustrating an example of a commodity purchase auxiliary system 1 according to the present embodiment. The commodity purchase auxiliary system 1 is used to assist purchase of a commodity that does not contain raw materials that a customer avoids. The raw material indicates a substance contained in the commodity, such as a material and an additive. The commodity purchase auxiliary system 1 includes a customer terminal 10 and a commodity server 20. The customer terminal 10 and the commodity server 20 are connected to each other in a communicable manner via a network such as the Internet. The number of the customer terminals 10 and the number of the commodity servers 20 in the commodity purchase auxiliary system 1 are not limited.

The customer terminal 10 is a portable terminal carried by a customer, such as a smartphone or a tablet terminal. The customer terminal 10 includes an image capturing section 106 (refer to FIG. 2) for capturing an image. For example, when the customer terminal 10 detects a code symbol such as a barcode or a two-dimensional code from a captured image, the customer terminal 10 scans a commodity code capable of identifying the commodity indicated by the code symbol.

The customer terminal 10 transmits a determination request to the commodity server 20 to determine whether or not the commodity whose commodity code is scanned contains the raw material that the customer avoids. The customer terminal 10 transmits a substitute request to the commodity server 20 to request information of a substitute commodity that does not contain the avoidance material that the customer avoids if the commodity whose commodity code is scanned contains the avoidance material.

The commodity server 20 stores various kinds of information relating to a commodity sold in the retail store. The commodity server 20 may include a plurality of servers. The commodity server 20 may be provided by a cloud service that provides computer resources such as hardware and software.

When the commodity server 20 receives the determination request from the customer terminal 10, the commodity server 20 determines whether or not the commodity which is the target of the determination request contains the avoidance material based on a commodity master file 208 (refer to FIG. 4) in which various kinds of information relating to the commodity are stored. Then, the commodity server 20 transmits a determination result to the customer terminal 10.

If the substitute request is received from the customer terminal 10, the commodity server 20 extracts a substitute commodity that does not contain the avoidance material from the commodity master file 208. Then, the commodity server 20 transmits information relating to the extracted substitute commodity to the customer terminal 10.

Next, the hardware configuration of each device included in the commodity purchase auxiliary system 1 is described.

FIG. 2 is a block diagram illustrating an example of a hardware configuration of the customer terminal 10. The customer terminal 10 includes a control section 101, a storage section 102, a communication interface 103, a display section 104, an operation section 105 and an image capturing section 106. These sections are mutually connected via a system bus 107 such as a data bus or an address bus.

The control section 101 is a computer which controls the overall operation of the customer terminal 10 to perform various functions of the customer terminal 10. The control section 101 includes a CPU (Central Processing Unit), a ROM (Read Only Memory), and a RAM (Random Access Memory). The CPU collectively controls the operation of the customer terminal 10. The ROM is a non-volatile storage medium that holds various kinds of data even when no electric power is supplied. The RAM is capable of reading and writing data from and to a designated area. Then, the CPU executes a program stored in the ROM, the storage section 102 or the like by using the RAM as a work area (working area).

The storage section 102 is an HDD (Hard Disk Drive), an SSD (Solid State Drive) or the like. The storage section 102 stores a control program 108 and avoidance information 109.

The control program 108 is an operating system or a program used for performing functions of the customer terminal 10. The control program 108 includes a program for performing a characteristic function according to the present embodiment.

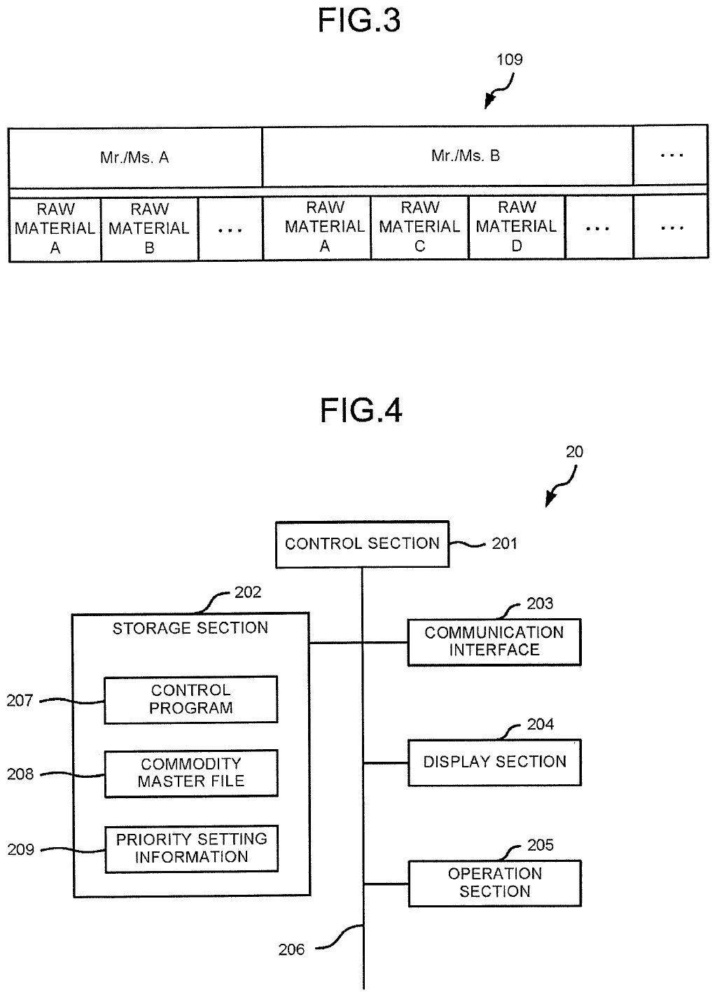

The avoidance information 109 is information in which the avoidance material indicating the raw material that the customer avoids is registered for each customer. Here, FIG. 3 is a diagram illustrating an example of a data structure of the avoidance information 109. As shown in FIG. 3, in the avoidance information 109, the avoidance material is registered for each customer. Thereby, in the avoidance information 109, not only the avoidance material for the customer who carries the customer terminal 10 but also the avoidance material for any customer such as the customer's family and friend can be registered. The avoidance material is, for example, any raw material such as an allergic substance, a raw material that cannot be ingested for religious reasons or alcohol. The avoidance information 109 may be stored not only in the storage section 102 but also in another server such as the commodity server 20.

The communication interface 103 is used for communicating with another device such as the commodity server 20 via a network.

The display section 104 is a liquid crystal display or the like, for example. The operation section 105 is, for example, a touch panel stacked on the display section 104. The operation section 105 detects a touch position on the display section 104 to determine that an operation associated with a display element displayed on the display section 104 is input. Thus, the operation section 105 receives an operation on a key if the key displayed on the display section 104 is operated. The operation section 105 is not limited to the touch panel, and may have a hardware key.

The image capturing section 106 is a camera provided with an image sensor such as a CCD (Charge Coupled Device) or a CMOS (Complementary Metal-Oxide Semiconductor).

FIG. 4 is a block diagram illustrating an example of the hardware configuration of the commodity server 20. The commodity server 20 includes a control section 201, a storage section 202, a communication interface 203, a display section 204 and an operation section 205. These sections are mutually connected via a system bus 206 such as a data bus or an address bus.

The control section 201 is a computer that controls the overall operation of the commodity server 20 to perform various functions of the commodity server 20. The control section 201 includes a CPU, a ROM and a RAM. The CPU collectively controls the operation of the commodity server 20. The ROM is a non-volatile storage medium that holds various kinds of data even when no electric power is supplied. The RAM is capable of reading and writing data from and to a designated area. Then, the CPU executes a program stored in the ROM, the storage section 202 or the like by using the RAM as a work area (working area).

The storage section 202 is an HDD, an SSD or the like. The storage section 202 stores a control program 207, the commodity master file 208 and priority setting information 209. The commodity master file 208 and the priority setting information 209 may be stored in another server or the like.

The control program 207 is an operating system or a program used for performing functions of the commodity server 20. The control program 207 includes a program for performing a characteristic function according to the present embodiment.

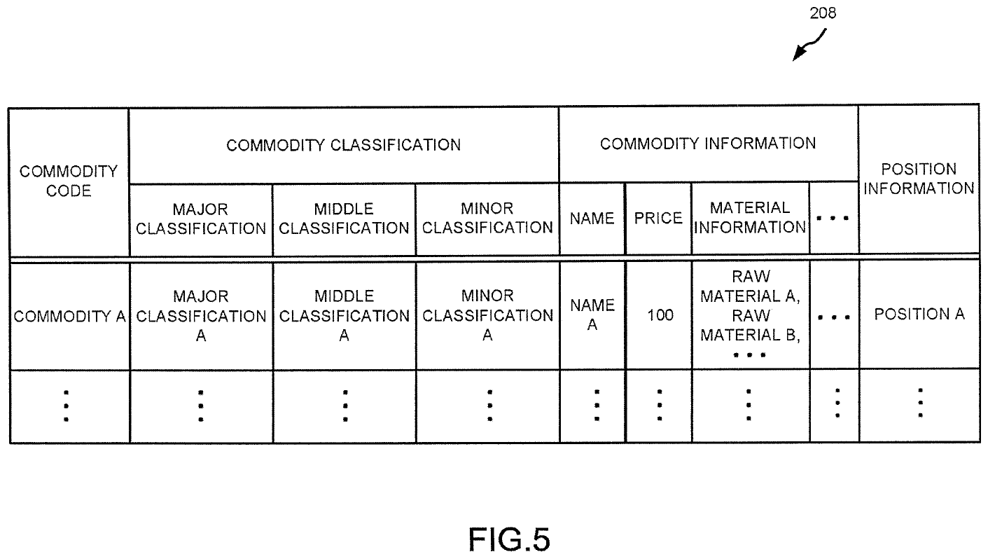

The commodity master file 208 is a database for storing various kinds of information relating to the commodity. Here, FIG. 5 is a diagram illustrating an example of the data structure of the commodity master file 208. The commodity master file 208 stores a commodity code, a commodity classification, commodity information and position information in an associated manner. The commodity code is identification information that can identify the commodity.

The commodity classification indicates classification of the commodity. For example, the commodity classification is divided into three categories: major classification, middle classification and minor classification. The major classification refers to a classification based on the division of the commodity. The middle classification refers to a classification based on use of the commodity. The minor classification refers to a classification based on a type of the commodity. As a specific example, the major classification refers to a division of roux used in curry and stew. The middle classification refers to an application of dishes such as curry and stew. The minor classification refers to a type of roux in curry. The commodity classification shown in FIG. 5 is divided into three stages: the major classification, the middle classification and the minor classification, but the number of the commodity classifications is not limited to three, and may be two or less, or four or more.

The commodity information includes various kinds of information of the commodity. For example, the commodity information includes a name, a price and material information. The material information is information in which the raw material of the commodity is registered. The position information indicates a position where the commodity is displayed at a sales floor in the retail store. For example, the position information may be a name of a position of a commodity shelf or the like where the commodity is displayed, coordinates indicating a position where the commodity is displayed, or a map indicating a position where the commodity is displayed.

The priority setting information 209 indicates setting of a priority set for each commodity if a plurality of the substitute commodities that does not include the avoidance material is extracted from the commodity master file 208. The commodity server 20 determines whether or not the avoidance material is contained in each commodity of the commodity master file 208 in the order of priority indicated by the priority setting information 209. Then, if the commodity server 20 detects a commodity that does not contain the avoidance material, the commodity server 20 extracts the commodity that does not contain the avoidance material as the substitute commodity.

The communication interface 203 is used for communicating with the customer terminal 10 via a network.

The display section 204 is a liquid crystal display or the like. The operation section 205 is an input device such as a keyboard or a mouse.

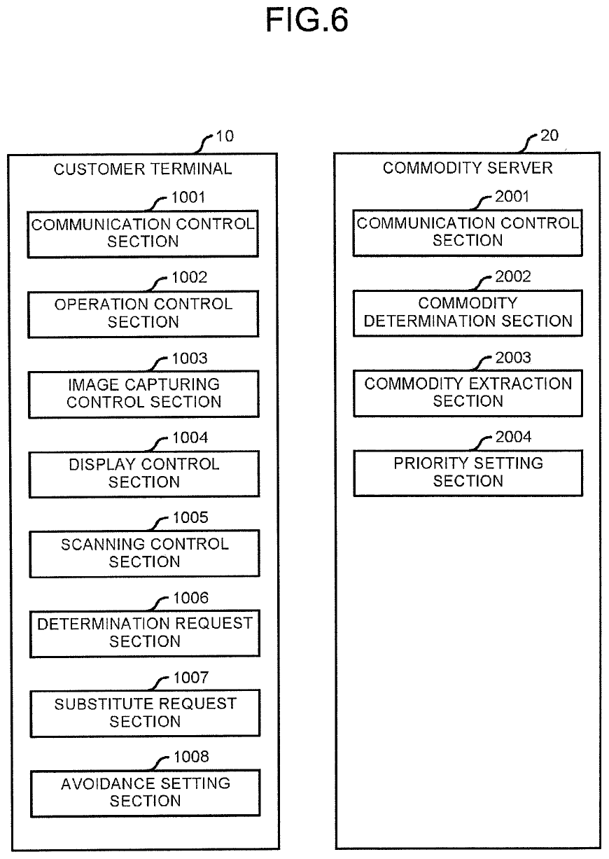

Next, the characteristic functions of each device included in the commodity purchase auxiliary system 1 are described. Here, FIG. 6 is a block diagram illustrating an example of characteristic functional components of each device included in the commodity purchase auxiliary system 1.

The control section 101 of the customer terminal 10 copies or decompresses the control program 108 stored in the storage section 102 on the RAM and executes the control program 108 to generate each functional section shown in FIG. 6 on the RAM. Specifically, the control section 101 of the customer terminal 10 includes a communication control section 1001, an operation control section 1002, an image capturing control section 1003, a display control section 1004, a scanning control section 1005, a determination request section 1006, a substitute request section 1007 and an avoidance setting section 1008 as functional sections.

The communication control section 1001 controls the communication interface 103 to control communication with a device connected to the network. For example, the communication control section 1001 controls communication with the commodity server 20.

The operation control section 1002 controls the operation section 105 to receive various operations.

The image capturing control section 1003 controls the image capturing section 106 to capture an image. For example, the image capturing control section 1003 controls the image capturing section 106 to capture an image of a code symbol indicating a commodity code.

The display control section 1004 controls the display section 104 to display various images.

The scanning control section 1005 executes a detection processing of detecting a code symbol from the image captured by the image capturing section 106 controlled by the image capturing control section 1003. The scanning control section 1005 scans the commodity code from the detected code symbol when the code symbol is detected from the image by the detection processing.

The determination request section 1006 transmits a determination request to the communication control section 1001 after the scanning control section 1005 scans the commodity code, wherein the determination request requests determination about whether or not the commodity specified by the scanned commodity code contains the avoidance material registered in the avoidance information 109. The determination request includes the commodity code scanned by the scanning control section 1005 and the avoidance information 109.

If the communication control section 1001 receives a determination result as a response to the determination request, the determination request section 1006 enables the display control section 1004 to display screen information included in the determination result. The determination request section 1006 enables the display control section 1004 to display a conformity screen based on the received screen information when the commodity does not contain the avoidance material. For example, the conformity screen displays a commodity name of a commodity whose commodity code is scanned by the scanning control section 1005 and that the commodity whose commodity code is scanned by the scanning control section 1005 does not contain the avoidance material.

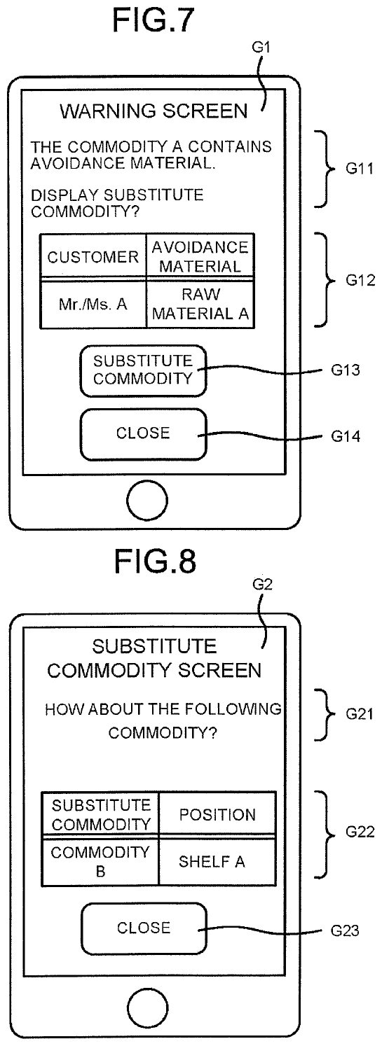

The determination request section 1006 enables the display control section 1004 to display a warning screen G1 based on the received screen information when the commodity contains the avoidance material. Here, FIG. 7 is a diagram illustrating an example of the warning screen G1. For example, the warning screen G1 includes a message display area G11, an avoidance list display area G12, a substitute commodity button G13, and a close button G14. In the message display area G11, a message is displayed for the customer. For example, in the message display area G11, a message indicating that the avoidance material is contained in the commodity identified by the commodity code scanned by the scanning control section 1005 is displayed. In the message display area G11, a message for inquiring whether to display a substitute commodity that is a substitute for the commodity identified by the commodity code scanned by the scanning control section 1005 is displayed. In the avoidance list display area G12, a list showing the avoidance material contained in the commodity and the customer who avoids the avoidance material is displayed. In the avoidance list display area G12 shown in FIG. 7, one avoidance material and one customer who avoids the avoidance material are displayed, but if there are plural avoidance materials and several customers who avoid the avoidance materials, the plural avoidance materials and the plural customers are displayed, respectively. The substitute commodity button G13 is used for receiving an operation for displaying the substitute commodity. The close button G14 is used for receiving an operation for closing the warning screen G1.

The substitute request section 1007 enables the communication control section 1001 to transmit a substitute request that requires the substitute commodity. For example, the substitute request section 1007 enables the communication control section 1001 to transmit the substitute request when the substitute commodity button G13 on the warning screen G1 is pressed. The substitute request includes the commodity code scanned by the scanning control section 1005 and the avoidance information 109.

The substitute request section 1007 enables the display control section 1004 to display a substitute commodity screen G2 based on received screen information of the substitute commodity if the communication control section 1001 receives the screen information of the substitute commodity as a response to the substitute request. Here, FIG. 8 is a diagram illustrating an example of the substitute commodity screen G2. The substitute commodity screen G2 includes a message display area G21, a substitute commodity list display area G22 and a close button G23. In the message display area G21, a message for recommending a substitute commodity that is a substitute for the commodity identified by the commodity code scanned by the scanning control section 1005 is displayed. In the substitute commodity list display area G22, a list of commodity information such as a name of the substitute commodity and position information of a commodity shelf at which the substitute commodity is placed is displayed. In the substitute commodity list display area G22 shown in FIG. 8, one substitute commodity is displayed, but a plurality of the substitute commodities may be displayed. The close button G23 is used for receiving an operation of closing the substitute commodity screen G2. The substitute commodity screen G2 may include a button for requesting display of a substitute commodity different from the displayed substitute commodity.

The avoidance setting section 1008 sets the avoidance material and the customer who avoids the avoidance material in the avoidance information 109. For example, when the avoidance material and the customer who avoids the avoidance material are input on a setting screen or the like, the avoidance setting section 1008 registers the input avoidance material and the customer who avoids the avoidance material in the avoidance information 109 in an associated manner. The control section 201 of the commodity server 20 copies or decompresses the control program 207 stored in the storage section 202 on the RAM and executes the control program 207 to generate each functional section shown in FIG. 6 on the RAM. Specifically, the control section 201 of the commodity server 20 includes a communication control section 2001, a commodity determination section 2002, a commodity extraction section 2003, and a priority setting section 2004 as functional sections.

The communication control section 2001 is an example of a reception module, a first transmission module and a second transmission module. The communication control section 2001 controls the communication interface 203 to control communication with a device connected to the network. For example, the communication control section 2001 controls communication with the customer terminal 10.

The communication control section 2001 receives a determination request for requesting determination about whether or not the avoidance material is contained in the commodity. Then, for example, the communication control section 2001 transmits screen information for displaying the conformity screen or screen information for displaying the warning screen G1 as the determination result of the determination request. The communication control section 2001 receives, for example, a substitute request that requests information relating to the substitute commodity. Then, for example, the communication control section 2001 transmits screen information for displaying the substitute commodity screen G2 as a response to the substitute request.

The commodity determination section 2002 is an example of a first extraction module and a second extraction module. When the communication control section 2001 receives the determination request, the commodity determination section 2002 determines whether or not the commodity designated by the determination request contains the avoidance material. More specifically, the commodity determination section 2002 extracts, from the commodity master file 208, material information in which raw materials of the commodity identified by the commodity code included in the determination request are registered. The commodity determination section 2002 extracts the avoidance information 109 from the determination request. Then, the commodity determination section 2002 determines whether or not the material information extracted from the commodity master file 208 contains the avoidance material registered in the avoidance information 109 extracted from the determination request.

The commodity determination section 2002 generates screen information for displaying the conformity screen if the commodity determination section 2002 determines that the material information of the commodity does not contain the avoidance material. On the other hand, if the commodity determination section 2002 determines that the material information of the commodity contains the avoidance material, the commodity determination section 2002 generates screen information for displaying the warning screen G1. The screen information for displaying the warning screen G1 includes information such as a name of the avoidance material included in the material information, and information such as the name of the customer who avoids the avoidance material registered in the avoidance information 109. Then, the commodity determination section 2002 enables the communication control section 2001 to transmit the generated screen information.

When the communication control section 2001 receives the substitute request, the commodity extraction section 2003 extracts a substitute commodity. More specifically, in the warning screen G1 displayed on the condition that the material information of the commodity which is the target of the determination request includes the avoidance material registered in the avoidance information 109, if the substitute commodity button G13 for requesting the substitute commodity is pressed, the communication control section 2001 receives the substitute request. In this case, based on the priority setting information 209, the commodity extraction section 2003 sets priorities to the other commodities in the minor classification to which the commodity identified by the commodity code included in the substitute request belongs. The commodity extraction section 2003 compares the material information of each commodity stored in the commodity master file 208 with the avoidance material registered in the avoidance information 109 included in the substitute request in the order of priority to determine whether or not the material information includes the avoidance material.

The commodity extraction section 2003 extracts commodity information and the position information of the corresponding commodity from the commodity master file 208 when the commodity which does not contain the avoidance material in the material information is detected. Then, the commodity extraction section 2003 generates screen information for displaying the substitute commodity screen G2 for recommending the detected commodity as the substitute commodity. The screen information for displaying the substitute commodity screen G2 includes the commodity information such as a name and the like of the commodity, and the position information indicating a position where the commodity is displayed. Then, the commodity extraction section 2003 enables the communication control section 2001 to transmit the screen information for displaying the substitute commodity screen G2.

The commodity extraction section 2003 extends an extraction range of the commodity to the middle classification to which the commodity identified by the commodity code included in the substitute request belongs if the commodity which does not contain the avoidance material cannot be extracted from the minor classification. Specifically, based on the priority setting information 209, the commodity extraction section 2003 sets priorities of commodities belonging to the other minor classifications included in the middle classification. The commodity extraction section 2003 determines whether or not the avoidance material is included in the material information of the commodity in the order of priority. Furthermore, when the commodity extraction section 2003 cannot extract a commodity that does not contain the avoidance material from the middle classification, the commodity extraction section 2003 extends the extraction range of the commodity to the major classification to which the commodity identified by the commodity code included in the substitute request belongs.

The priority setting section 2004 changes the setting of the priority indicated by the priority setting information 209. For example, if an input for changing the setting of the priority is received, the priority setting section 2004 changes the priority setting information 209 based on the input content. The input for changing the setting of the priority may be received by the operation section 205 or the communication interface 203.

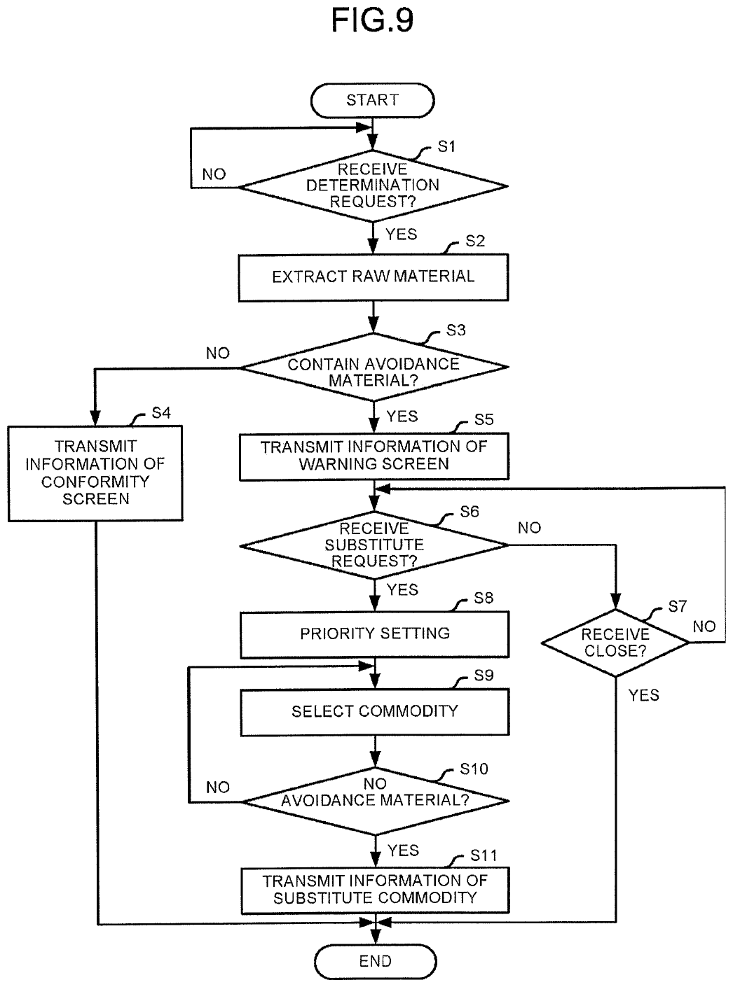

Next, an auxiliary processing performed by the commodity server 20 is described. Here, FIG. 9 is a flowchart depicting an example of the auxiliary processing performed by the commodity server 20 according to the present embodiment.

The communication control section 2001 determines whether or not a determination request has been received (Act S1). The commodity server 20 stands by if no determination request is received (No in Act S1).

If it is determined that the determination request has been received (Yes in Act S1), the commodity determination section 2002 extracts material information of the commodity identified by the commodity code included in the determination request from the commodity master file 208 (Act S2). In other words, the commodity determination section 2002 extracts the raw material of the commodity.

The commodity determination section 2002 compares the extracted material information with the avoidance material registered in the avoidance information 109 included in the determination request to determine whether or not the material information contains the avoidance material (Act S3). If the material information does not include the avoidance material (No in Act S3), the communication control section 2001 transmits the screen information for displaying the conformity screen on the customer terminal 10 that has transmitted the determination request (Act S4). Then, the commodity server 20 terminates the auxiliary processing.

If the material information includes the avoidance material (Yes in Act S3), the communication control section 2001 transmits the screen information for displaying the warning screen G1 on the customer terminal 10 that has transmitted the determination request (Act S5).

The communication control section 2001 determines whether or not the substitute request has been received (Act S6). The communication control section 2001 determines whether or not information indicating that the warning screen G1 is closed has been received (Act S7) if no substitute request is received (No in Act S6).

If the information indicating that the warning screen G1 is closed is not received (No in Act S7), the commodity server 20 returns to the processing in Act S6. The commodity server 20 terminates the auxiliary processing if the information indicating that the warning screen G1 is closed has been received (Yes in Act S7).

If the substitute request has been received (Yes in Act S6), the commodity extraction section 2003 sets priorities to the commodities included in the commodity master file 208 (Act S8).

The commodity extraction section 2003 selects a commodity with the highest priority, for which the determination about whether or not the avoidance material is contained is not performed yet (Act S9).

The commodity extraction section 2003 determines whether or not the material information of the selected commodity includes the avoidance material (Act S10). The commodity server 20 returns to the processing in Act S9 if the material information of the selected commodity includes the avoidance material (No in Act S10).

The communication control section 2001 transmits the screen information for displaying the substitute commodity screen G2 to the customer terminal 10 that has been transmitted determination request (Act S11) if the material information of the selected commodity does not include the avoidance material (Yes in Act S10).

Thus, the commodity server 20 terminates the auxiliary processing.

As described above, the commodity server 20 according to the present embodiment extracts the raw material of the commodity identified by the commodity code included in the determination request from the commodity master file 208 if the determination request for determining whether or not the commodity contains the avoidance material. The commodity server determines whether or not the extracted raw material includes the avoidance material registered in the avoidance information 109. The commodity server 20 extracts commodity information of a commodity that does not contain the avoidance material when the raw material contains the avoidance material. Then, the commodity server 20 transmits the screen information for displaying the substitute commodity screen G2 for recommending the commodity that does not contain the avoidance material as the substitute commodity. Therefore, the commodity server 20 according to the present embodiment can assist in the purchase of the commodity that does not contain the raw material being avoided.

While certain embodiments have been described, these embodiments have been presented by way of example only, and are not intended to limit the scope of the invention. Indeed, the novel embodiments described herein may be embodied in a variety of other forms; furthermore, various omissions, substitutes and changes in the form of the embodiments described herein may be made without departing from the spirit of the invention. The accompanying claims and their equivalents are intended to cover such forms or modifications as would fall within the scope and spirit of the invention.

In the above embodiment, the avoidance information 109 is stored in the customer terminal 10. The customer terminal 10 transmits the determination request including the avoidance information 109. Then, the commodity server 20 determines whether or not the avoidance material is contained in the commodity using the avoidance information 109 included in the determination request. However, the avoidance information 109 may be stored in the commodity server 20. In this case, the customer terminal 10 transmits a determination request including a customer code capable of identifying a customer. The commodity server 20 uses the customer code included in the determination request to extract the avoidance information 109 associated with the customer code. Then, the commodity server determines whether or not the commodity contains the avoidance material based on the extracted avoidance information 109.

The programs to be executed by each device of the foregoing embodiment and the modification may be incorporated into a storage medium (ROM or storage section) of each device to be provided; however, it is not limited thereto. The programs may be recorded in a computer-readable recording medium such as a CD-ROM (Compact Disc Read-Only Memory), an FD (Flexible Disk), a CD-R (Compact Disk Recordable), a DVD (Digital Versatile Disk) and the like in the form of installable or executable file to be provided. Further, the storage medium is not limited to a medium independent from a computer or an embedded system and also contains a storage medium that stores or temporarily stores the programs by downloading the programs transmitted through an LAN (Local Area Network) or the Internet.

Further, the programs to be executed by each device of the foregoing embodiment and the modification may be stored in a computer connected with the network such as the Internet and downloaded via the network to be provided or may be provided or distributed via the network such as the Internet.

1-20. (canceled)

21. A system for use with a customer terminal carried in a store, the system comprising:
a master file database comprising:
a target material information associated with a first commodity,
a target first classification associated with the first commodity,
a target second classification associated with the first commodity,
a first substitute material information associated with a first substitute commodity,
a first substitute first classification associated with the first substitute commodity,
a first substitute second classification associated with the first substitute commodity,
a second substitute material information associated with a second substitute commodity,
a second substitute first classification associated with the second substitute commodity, and
a second substitute second classification associated with the second substitute commodity;
a server comprising:
a central processing unit configured to:
receive a first commodity code capable of identifying a target commodity,
provide the first commodity code to the master file database,
receive, from the master file database, the target material information, the target first classification, and the target second classification, after providing the first commodity code to the master file database,
determine whether the target material information includes an avoidance material,
after determining that the target material information includes the avoidance material, receive, from the master file database, the first substitute material information, the first substitute first classification, the first substitute second classification, the second substitute material information, the second substitute first classification, and the second substitute second classification,
compare the target first classification to the first substitute first classification and compare the target first classification to the second substitute first classification,
when the first substitute first classification matches the target first classification and the second substitute first classification matches the target first classification, compare the target second classification to the first substitute second classification and compare the target second classification to the second substitute second classification, and
when the first substitute first classification matches the target first classification, the second substitute first classification matches the target first classification, the first substitute second classification matches the target second classification, and the second substitute second classification does not match the target second classification, cause the first substitute material information to be displayed on a display of the customer terminal.

22. The system according to claim 21, the central processing unit is further configured to, when the first substitute first classification matches the target first classification, the second substitute first classification matches the target first classification, the second substitute second classification matches the target second classification, and the first substitute second classification does not match the target second classification, cause the second substitute material information to be displayed on the display of the customer terminal.

23. The system according to claim 21, the central processing unit is further configured to, when the first substitute first classification matches the target first classification and the second substitute first classification does not match the target first classification, cause the first substitute material information to be displayed on the display of the customer terminal.

24. The system according to claim 21, wherein the central processing unit is further configured to cause a name of the avoidance material to be displayed on the display of the customer terminal, when the target material information includes the avoidance material.

25. The system according to claim 21, wherein the central processing unit is further configured to cause a name of a customer associated with the avoidance material to be displayed on the display of the customer terminal.

26. A method of operating a commodity server including a central processing unit, the method comprising:
receiving, by the central processing unit from a customer terminal in a store, a commodity code identifying a target commodity in the store;
extracting, by the central processing unit, material information in which first raw materials contained in the target commodity are registered;
extracting, by the central processing unit, commodity information of a first substitute commodity that does not contain an avoidance material associated with a customer;
extracting, by the central processing unit, commodity information of a second substitute commodity that does not contain the avoidance material;
determining, by the central processing unit, a target first classification and a target second classification of the first substitute commodity;
determining, by the central processing unit, a first substitute first classification and a first substitute second classification of the first substitute commodity;
determining, by the central processing unit, a second substitute first classification and a second substitute second classification of the second substitute commodity;
comparing, by the central processing unit, the target first classification and the first substitute first classification;
comparing, by the central processing unit, the target first classification and the second substitute first classification;
when the target first classification matches the first substitute first classification and the target first classification matches the second substitute first classification, comparing, by the central processing unit, the target second classification and the first substitute second classification; and
when the target second classification matches the first substitute second classification, causing, by the central processing unit, the extracted commodity information of the first substitute commodity to be displayed by the customer terminal.

27. The method of claim 26, further comprising receiving, by the central processing unit from the customer terminal, a determination request,
wherein the commodity code identifying the target commodity is received by the central processing unit upon receiving the determination request; and
wherein the commodity code identifying the target commodity is not received by the central processing unit in the absence of the determination request.

28. The method of claim 26, further comprising causing, by the central processing unit, transmission of information of conformity to the customer terminal when extracting the avoidance information results in no record.

29. The method of claim 26, further comprising receiving, by the central processing unit, a request for substitution at the customer terminal prior to extracting the commodity information of the first substitute commodity and extracting the commodity information of the second substitute commodity.

30. A computer system for providing food substitution information, the computer system comprising:
a customer terminal configured to be utilized by a customer, the customer terminal comprising a display; and
a server comprising a controller configured to:
determine a target commodity associated with the customer,
determine an allergic substance associated with the customer,
determine whether the target commodity contains the allergic substance;
after determining that the target commodity contains the allergic substance:
determine a target first classification and a target second classification of the target commodity,
determine a first substitute commodity based on the target first classification, the first substitute commodity having a first substitute first classification and a first substitute second classification, and
determine a second substitute commodity based on the target first classification, the second substitute commodity having a second substitute first classification and a second substitute second classification;
determine whether the first substitute first classification matches the target first classification;
determine whether the second substitute first classification matches the target first classification;
determine whether the first substitute commodity contains the allergic substance; and
cause the display to provide information associated with the first substitute commodity when: the first substitute first classification matches the target first classification, the second substitute first classification does not match the target first classification, and the first substitute commodity does not contain the allergic substance.

31. The computer system of claim 30, wherein the controller is further configured to:
determine whether the second substitute commodity contains the allergic substance; and
cause the display to provide information associated with the second substitute commodity when: the second substitute first classification matches the target first classification, the first substitute first classification matches the target first classification, the second substitute second classification matches the target second classification, the first substitute second classification does not match the target second classification, and the second substitute commodity does not contain the allergic substance.

32. The computer system of claim 30, wherein the controller is further configured to cause the display to provide a warning indicating that the allergic substance is included in the target commodity.

33. The computer system of claim 30, wherein the warning includes a name of the customer and a name of the allergic substance.

34. The computer system of claim 30, wherein:
the customer terminal further comprises a camera;
the controller is configured to cause the camera to capture an image of the target commodity; and
the controller is configured to determine the target commodity based on the image.

35. The computer system of claim 30, wherein the controller is further configured to:
after determining the target commodity, extract information of target raw materials associated with the target commodity from a commodity database storing information of a plurality of commodities and a plurality of raw materials; and
determine whether the target commodity contains the allergic substance by comparing the allergic substance to the target raw materials.

36. The computer system of claim 35, wherein the information comprises a position of the first substitute commodity in a store.
